(19) United States
(12) Patent Application Publication
(10) Pub. No.: US 2012/0173672 A1
(43) Pub. Date: Jul. 5, 2012

(54) HIERARCHICAL NETWORK HAVING DECENTRALIZED ADMINISTRATION

(75) Inventors: Frank Hakemeyer, Horn-Bad Meinberg (DE); Vladimir Frose, Bad Oeynhausen (DE); Stefan Witte, Minden (DE); Maik Stemme, Auetal (DE)

(73) Assignee: PHOENIX CONTACT GMBH & CO. KG, Blomberg (DE)

(21) Appl. No.: 13/496,765

(22) PCT Filed: Sep. 17, 2010
(86) PCT No.: PCT/EP2010/063695

§ 371 Date: Mar. 16, 2012

(30) Foreign Application Priority Data
Sep. 18, 2009 (DE) 10 2009 041 821.0

(51) Int. Cl. G06F 15/16

(52) U.S. Cl. 709/217

(57) ABSTRACT

The invention relates to a network comprising at least one first client (2), one second client (3a, 3b), one third client (4a, 4b, 4c, 4d) and one message transmission device (6) for transmitting messages between the clients, wherein the first client (2) is arranged in a first network level, the second client (3a, 3b) is arranged in a second network level and the third client (4a, 4b, 4c, 4d) is arranged in a third network level, wherein the first network level is superior to the second network level and the second network level is superior to the third network level, wherein the network is configured so that the second client (3a, 3b) and the third client (4a, 4b, 4c, 4d) can initiate the transfer of a message between the second client (3a, 3b) and the third client (4a, 4b, 4c, 4d), wherein the transfer of the message between the second network level and the third network level.

The invention relates to a network comprising multiple clients and a message transmission device for transmitting messages between the clients.

Networks having multiple clients, wherein messages can be transferred between them by means of a message transmission device, are well known. The clients may be arranged within the network in various logical structures; it is well known to arrange the clients in form of a tree structure. In a tree structure, one client is on top, and the other clients connect to that client. The client on top of the tree structure is part of a topmost first network level; the clients directly connected to this client are part of a second network level, which is inferior to the first network level; the clients directly connected to the latter clients are part of a third network level, which is inferior to the second network level, etc. The logical tree structure allows only connections between clients of adjoining network levels. Connections within one network level are not allowed. Furthermore, in addition to being connected to the client on top of the tree structure, a client is also connected exactly to one client of an adjoining superior network. Furthermore, multiple clients of an inferior network level may be connected with a single client of an adjoining superior network level.

The clients of a network are also called “network nodes” or “nodes”. Depending on the function of the client, the clients can be classified as master client, repeater slave client, and slave client. The master client forms the central point of the network. The master client performs initializations and network specific functions. The network cannot function without a master client. The client on top of a tree structure is a master client. A repeater slave client is arranged to transmit messages between adjoining clients. A slave client does not transmit messages. Slave clients are always terminal points of the network.

As described, networks are usually managed by a central unit, for example a master client. In particular, the “management” comprises organization, administration and control of the network. One example of a network managed by a central unit is the WLAN system known as the IEEE 802.11 standard, wherein an access point is the central unit, which administers and services clients. Another example is the new wireless HART technology, which is based on the IEEE 802.15.4 standard and uses a central unit for organizing, administering and controlling, the radio network.

The disadvantage of a network managed by a central unit is that a message, which must be transmitted from the central unit to a client for managing the network, may be transferred via the entire network. In a network comprising multiple network levels, the clients aligned between the central unit and the client, for which the message is intended, must transmit the message. This leads to increased network traffic and in the case of a radio network to more activities in the radio spectrum. Furthermore, the clients arranged in between are burdened with additional traffic, which results in a higher power requirement of the network.

Furthermore, a network managed by a central unit requires bundling of network administration in one device. In this situation, the risk arises that the entire management knowledge can be lost due to a failure of that device. In addition, high processing power is required for that device, resulting in a high demand for energy and in higher costs.

The object of the present invention is to create a network allowing reduced network traffic.

The object is solved by providing a network in accordance with the independent claim. Advantageous embodiments of the invention are specified in the dependent claims.

The inventive network comprises at least one first client, one second client, one third client, and one message transmission device for transmitting messages between the clients, wherein the first client is arranged in a first network level, the second client in arranged in a second network level, and the third client is arranged in a third network level, wherein the first network level is superior to the second network level and the second network level is superior to the third network level, wherein the network is configured so that the second client and the third client can initiate the transfer of a message between the second client and the third client, wherein the transfer of the message is restricted to the transfer of the message between the second network level and the third network level.

The network according to the invention is decentralized. This means that messages transferred in the network do not exclusively address a central unit of the network or are sent by a central unit of the network. Instead, messages between clients can also be transferred without the involvement of a central unit. This allows the reduction of the traffic load within the network. In this way the central unit can be unburdened and the power consumption in the network can be reduced.

Additional network levels may be located between the first and the second network level and/or between the second and the third network level. However, it is preferred that the first and the second network level as well as the second and the third network level are directly adjoining.

Preferably, the message is a network management message for managing the network. The “network management” is understood as the organization, administration, and control of the network. Accordingly, network management messages organize, administer, and control the network.

In one preferred embodiment, the network comprises further a first subnetwork and a second subnetwork, wherein the first client and the second client are clients of the first subnetwork and the second client and the third client are clients of the second subnetwork, wherein the first subnetwork is limited to clients between the first network level and the second network level and the second subnetwork is limited to clients between the second and the third network level, wherein at least two clients of the relevant subnetwork can initiate the transfer of a message within the first subnetwork and the second subnetwork and wherein the transfer of the message is limited to the relevant subnetwork.

In particular, multiple subnetworks can be arranged in parallel between common network levels.

In another preferred embodiment, the second subnetwork has exactly one client, which is a client of the superior first subnetwork. Preferably, the clients of one subnetwork, which are also clients of a superior subnetwork, take on at least a part of the network management of the inferior subnetwork. Therefore, because a subnetwork has exactly one client, which is also a client of the superior subnetwork, exactly one client is responsible for the network management within the inferior subnetwork. Problems pertaining to responsibilities can be avoided in this manner. In addition, it is clearly defined in the superior subnetwork which client is responsible for the network management in the inferior subnetwork.

Preferably, the transfer of the message is exclusively done from an inferior network level to a superior network level and/or from a superior network level to an inferior network level.

In particular it is preferred that the network has a network structure in form of a tree structure.

Preferably, the first client is a master client. The second client is preferably a repeater slave client; the third client is a repeater slave client or a slave client. With more than three adjoining network levels, the first client can alternatively be a repeater slave client.

The invention is explained in more detail in preferred embodiments below by referring to the attached figures.

In the figures:

FIG. 1 shows a schematic diagram of an embodiment of the inventive network,

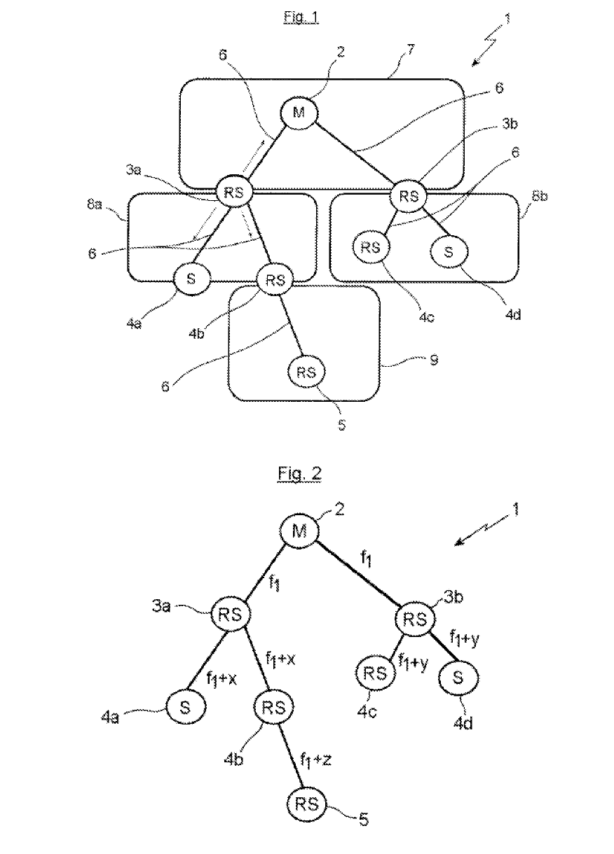

FIG. 2 shows the network shown in FIG. 1, executing a first management function, and

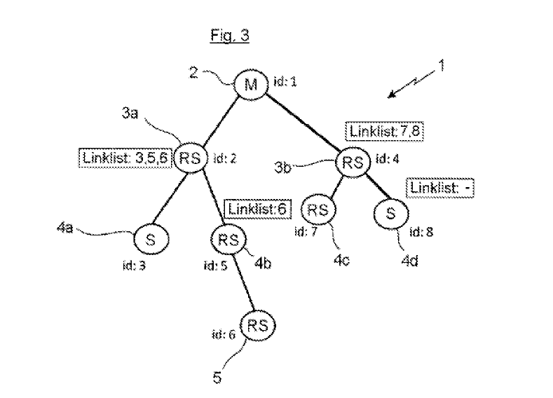

FIG. 3 shows the network shown in FIG. 1, executing a second management function.

FIG. 1 shows an embodiment of the network according to the invention in a schematic diagram.

Network 1 is structured as a tree structure comprising four network levels. A first client 2 is at the first network level, which forms the top of the tree structure. The second client 2, in this case a master client, performs initializing functions and other network related functions. Two second clients 3a, 3b are in a second network level, which is inferior to the first network level, and both clients in this embodiment are designed as repeater slave clients. The main function of the second clients 3a, 3b is transferring messages. Four third clients 4a, 4b, 4c, 4d are in the third network level, which is inferior to the second network level. The two third clients 4a and 4b are connected to the second client 3a, and two additional third clients 4c, 4d are connected to the second client 3b. Two of the four third clients 4a, 4d are designed as slave clients, the other two of the four third clients 4b, 4c are designed as repeater slave clients. Three of the four third clients, the third clients 4a, 4c and 4d, are terminal points of the network 1. The fourth network level comprises a fourth client 5. The fourth client 5 is connected with the third client 4b. The fourth client 5 is designed as a repeater slave client; however, this client functions as a terminal point of network 1. A message transmission device 6 provides the connection between the individual clients of network 1, wherein the messages between the clients of the network are transmissible via this device. The network 1 is configured so that the transfer of a message is done exclusively from an inferior network level to a superior network level and/or from a superior network level to an inferior network level.

In this embodiment, the network 1 is designed as a radio network, wherein the first client 2, the second clients 3a, 3b, the third clients 4a, 4b, 4c, 4d, and the fifth client 5 are designed as radio stations. The message transfer is done via radio waves. The message transmission device 6 transmits radio waves between the individual clients, which, in particular, can be designed as air waves. Alternatively, network 1 can be designed as a network 1 connected by wires. In this case, the message transmission device 6 comprises one or more wires and/or conducting paths that connect the clients of network 1 for transmitting messages.

As shown in FIG. 1, each client of the network 1, with the exception of the first client 2, has exactly one connection with another client, which is arranged in an adjoining superior network level. In contrast, a client can have connections to multiple clients arranged in an inferior network level. For example, a second client 3a may have exactly one connection with a first client, here the first client 2, and may have two connections with inferior third clients, here the clients 4a, 4b. Naturally, more than two inferior clients can be connected to a superior client.

The network 1 is subdivided in four subnetworks 7, 8a, 8b, 9. The first subnetwork 7 comprises the first client 2 and the second clients 3a, 3b; the second subnetwork 8a comprises the second client 3a and the two third clients 4a, 4b; the third subnetwork 8b comprises the other second client 3b and the remaining two third clients 4c, 4d; the fourth subnetwork 9 comprises the third client 4b and the fourth client 5. The second client 3a is a client of both: the first subnetwork 7 and the second subnetwork 8a; the other second client 3b is a client of both: the first subnetwork 7 and the third subnetwork 8b. The third client 4b is a client of both: the second subnetwork 8a and the fourth subnetwork 9. The second subnetwork 8a and the third subnetwork 8b are arranged parallel between the second network level and the third network level.

Network 1 is configured so that the transfer of a message can be initiated within the first subnetwork 7, the second subnetwork 8a, the third subnetwork 8b, and the fourth subnetwork 9 between clients of the relevant subnetwork, wherein the transfer of the message is limited to the relevant subnetwork. In this embodiment, the message is a network management message for managing the subnetwork. Network 1 is configured so that the clients, which are part of a superior subnetwork and part of an inferior subnetwork, take on at least a part of the network management of the inferior subnetwork. In this embodiment, the second client 3a takes on the network management functions of the second subnetwork 8a; the other second client 3b takes on the network management functions of the third subnetwork 8b and the third client 4b takes on the network management functions of the fourth subnetwork 9.

For example, the network management message may be a synchronizing message, which the superior client, for example the second client 3a, also called “parent”, transfers to the third clients 4a, 4b, also called “children”. Using this synchronizing message, the third clients 4a, 4b can synchronize with the second client 3a and adapt their internal clocks to that client.

In addition, the message may be an admission request message, which is initiated by one “child”, for example the third client 4a, to inform the parent, in this case the second client 3a, that it wants to be adopted to the network 1. In the event of a successful adoption to the network 1, the second client 3a can transfer an admission confirmation message to the adopted child, in this case the third client 4a.

In addition, the message transferred within a subnetwork 7, 8a, 8b, 9 may be a transfer frequency message, in which the parent instructs one or both of its children, for example, the second client 3a instructs the third clients 4a, 4b, to change the frequency band at which messages are transferred between the parent and the children. An example of this is shown in FIG. 2. The first client 2 communicates with its children, the second clients 3a, 3b, at a frequency band f₁. The second client 3a communicates with its children, the third clients 4a, 4b, to change to a new frequency band f₁+x. Likewise, the second client 3b instructs its children, here the third clients 4c, 4d, to change to the frequency band f₁+y as well. The third client 4b instructs its children, here the fourth client 5, to change to the frequency band f₁+z.

In addition, the network management message may be designed as an identification query message or as an identification transmitting message. An example of this is explained in more detail by referring to FIG. 3.

Identification numbers (ID numbers) 1 to 6 are assigned to the individual clients of network 1. By transferring an identification query message from the parents to their children and by the transfer of an identification transmitting message from the children to their parents, a list (linked list) is created at each parent containing the identification numbers of the inferior clients connected to a particular parent. In this way, the master client 2 receives from its children, the second clients 3a, 3b, a list of the connections listing all clients connected to the master client 2, without the master client 2 having to make an inquiry about the identification number of each individual client.

Furthermore, the network management message may be a transmitting power adaption message, by which a parent controls the transmitting power of its children. Conversely, a parent can adapt its own transmitting power based on a received field intensity message transferred by a child. In this manner, parent and children can optimize their transmitting power.

Furthermore, the network management message may be a message initiated by a parent to one of its children instructing it to seek another parent, to activate an installation mode, or to activate a sleep mode in order to install or to deactivate a child.

### REFERENCE LIST

Network 1
Master client 2
Repeater slave client 3a, 3b, 4b, 4c, 5
Slave client 4a, 4d
Message transmission device 6
First subnetwork 7
Second subnetwork 8a
Third subnetwork 8b
Fourth subnetwork 9

1-8. (canceled)

9. A network comprising:
at least one first client, one second client, one third client, and one message transmission device for transmitting messages between the clients,
wherein the first client is arranged in a first network level, the second client is arranged in a second network level, and the third client is arranged in a third network level,
wherein the first network level is superior to the second network level and the second network level is superior to the third network level,
wherein the network is configured so that the second client and the third client can initiate the transfer of a message between the second client and the third client,
wherein the transfer of the message is restricted to the transfer of the message between the second network level and the third network level,
the network further comprising a first subnetwork and a second subnetwork,
wherein the first client and the second client are clients of the first subnetwork and the second client and the third client are clients of the second subnetwork,
wherein the first subnetwork is limited to clients between the first network level and the second network level, and the second subnetwork is limited to clients between the second network level and the third network level,
wherein the transfer of a message between at least two of the clients of the relevant subnetwork can be initiated within the first subnetwork and the second subnetwork,
wherein the transfer of the message is limited to the relevant subnetwork.

10. The network according claim 9, wherein the second subnetwork has exactly one client, which is a client of the superior first subnetwork.

11. The network according claim 9, wherein the network is configured so that the transfer of the message is exclusively done from a inferior network level to a superior network level and/or from a superior network level to a inferior network level.

12. The network according to claim 9, wherein the message is a network management message to manage the network, more specifically a synchronizing message, an admission request message, an admission confirmation message, a transfer frequency message, a transmitting power adaption message, an identification query message, an identification transmitting message, a linked list query message, and/or a linked list transmitting message.

13. The network according to claim 9, wherein the first client is a master client, the second client is a repeater slave client, and the third client is a repeater slave client or a slave client.

14. The network according to claim 9, wherein the network is structured as a tree structure.

15. The network according to claim 9, wherein the network is configured as a radio network, the first client, the second client, and the third client are radio stations and the transfer of messages is done via radio waves.
